(19) United States
(12) Patent Application Publication
(10) Pub. No.: US 2023/0315925 A1
(43) Pub. Date: Oct. 5, 2023

(54) LIBRARY-BASED CONNECTIONS DESIGN AUTOMATION

(71) Applicant: Autodesk, Inc., San Rafael, CA (US)

(72) Inventors: Mihai Stancu, Bucharest (RO); Cosmin Paul Manoliu, Bucharest (RO); Dan Florin Peticila, Bucharest (RO); Pawel Piechnik, Modlniczka (PL); Mihai Vlad Catalina, Bucharest (RO); Dragos Leonardo Olaru, Bucharest (RO); Vlad Pavel, Buchares (RO); Dumitru Berteanu, Bucharest (RO); Bogdan Orzea, East York (CA); Silviu Constantin Nita, Bucharest (RO); Amalia Elena Constantin, Fagaras (RO)

(73) Assignee: Autodesk, Inc., San Rafael, CA (US)

(21) Appl. No.: 17/713,724

(22) Filed: Apr. 5, 2022

(51) Int. Cl. G06F 30/12; G06F 30/13; G06F 30/17

(52) U.S. Cl. CPC G06F 30/12; G06F 30/13; G06F 30/17; G06F 2111/20

(57) ABSTRACT

A method and system provides the ability to connect steel elements. A design intent model is acquired and consists of a building information model of a skeleton of a building without connections between steel elements that have geometric characteristics. A structural analysis of the structure of the model is performed and generates output consisting of member end forces at intersections of the steel elements. Via a user interface, rules are defined, that associate a potential connection with a structural steel profile. Via a user interface, a script is defined, that dictate where connections should be placed by: identifying second geometric characteristics of the potential connection, identifying forces for steel elements to be connected, comparing the design intent model, the structural analysis output and the rules to the structural steel profile, and autonomously generating and placing, based on the comparison, connections on the BIM model at applicable intersections.

### BACKGROUND OF THE INVENTION

### 1. Field of the Invention

The present invention relates generally to building information modeling (BIM) software, and in particular, to a method, apparatus, system, and article of manufacture for automating the creation and placement of steel connections within a BIM model.

### 2. Description of the Related Art

In the architectural, engineering, and construction (AEC) industry, and there is often collaboration between the engineers, fabricators, and detailers. BIM software provides the foundation of digital transformation in the AEC industry and enables a more efficient collaboration.

Within BIM modeling, there are different levels of development (LOD) that identify the overall state of the BIM model at a particular point in its design process. For example, LOD 100 is the conceptual stage at the beginning of a project, LOD 200 is the approximate geometry stage similar to schematic design and design development, LOD 300 is the first precise geometry stage similar to construction documents where a design begins to accurately resemble what will be installed, LOD 400 is the second precise geometry stage that is achieved when fabrication and assembly can be driven directly from the model, and LOD 500 is the post construction as-built stage of a project.

Transitioning from LOD 100 to LOD 500 involves complexities and modeling by various parts of the AEC team. One of the more complex LOD transitions (from LOD 300 to LOD 400) involves the creation and placement of steel connections. As used herein, steel connections refer to bonders (e.g., bolts, welds, steel plates, and other small steel profiles) that help people join steel elements (e.g., beams, columns, and plates). Unfortunately, design and modeling of steel connections can be time consuming for structural engineers, steel detailers, or anyone else involved in the design/construction process. More specifically, specific steel connections need to be placed in specific positions based on complex calculations and team member preferences. In the prior art, a structural engineer performs the calculations and the modeling is either done by the same structural engineer or a person that relies on instructions coming from the structural engineer. In this regard, each steel connection is manually placed into a BIM model while taking into consideration the calculations, preferences, etc. The creation and placement of such steel connections and transitioning from LOD 300 to LOD 400 can take ten times (10×) the amount of time than performing the modeling work to build LOD 200 steel models (i.e., simply modeling the columns and beams).

In view of the above, it is desirable to automate the placement of steel connections that takes into consideration both the structural engineering specifications and information/preferences from other project team members (e.g., fabricators or other team members that have preferences that need to be considered during the BIM automation process). It is also desirable to provide a solution for the generation and placement of steel connections that can be used by everyone in an AEC project team. If is further desirable to make it easier for different AEC team members/users to get on board with the design workflow.

### SUMMARY OF THE INVENTION

In the prior art, structural engineers need to place steel connections as part of creating a more detailed BIM model. Embodiments of the invention overcome the problems of the prior art by providing the ability to perform an automated creation and placement of such steel connections. Such capabilities enable the ability to provide more accurate and earlier estimates of the cost and constructability of a building project than exists in the prior art. In addition, iterations during the design process are reduced by incorporating design and fabrication rules. Further, using the invention, different AEC team members such as steel detailers are able to automatically generate and place steel connections (e.g., rather than and/or in addition to structural engineers).

To provide such capabilities, embodiments of the invention utilize nodes which, when grouped in precise configurations inside scripts, define typical rules of how structural engineers need to model connections. A new user interface further allows the definition of other rules for the same purpose. The automated system works by jointly using rules from the scripts and the user interface.

Further to the above, it may be noted that structural engineers often place connectors based on national design codes, tables that dictate associations between specific configurations of connections, and steel profile sizes, and other industry practices. Within a framework of embodiments of the invention, each of these elements are mapped to each other and used during the automated steel connection placement.

Embodiments of the invention enable full rule automation that provides advantages for the use and sale of a BIM model to a structural engineer. More specifically, embodiments of the invention blend rules that account for: (i) structural analysis results; (ii) associations with steel profile sizes and other geometrical, material and cross-sectional characteristics of the connected members; and (iii) geometrical characteristics of the building model. Further, embodiments of the invention provide the ability for the user to customize all of these blended rules, either within a BIM software user interface or via a visual programming platform/script for the BIM software. Prior art systems fail to provide the ability to incorporate such rules (or only take into account some of the rules) resulting in less efficient or inapplicable automation routines.

### BRIEF DESCRIPTION OF THE DRAWINGS

Referring now to the drawings in which like reference numbers represent corresponding parts throughout:

FIG. 1 illustrates exemplary steel connections utilized in accordance with one or more embodiments of the invention;

FIG. 2A illustrates an exemplary DYNAMO script player that is used to execute/play DYNAMO scripts that place steel connections in accordance with one or more embodiments of the invention;

FIG. 2B illustrates a DYNAMO script user interface from the DYNAMO REVIT visual programming add-in for the REVIT BIM application, where preferences can be adjusted in accordance with one or more embodiments of the invention;

FIG. 3 illustrates a user interface (UI) for defining connection rules/ranges of applicability (for a connection) in accordance with one or more embodiments of the invention;

FIGS. 4A and 4B illustrate exemplary tables of the prior art;

FIG. 5 illustrates Table 10-1 of the prior art that may be encoded into a script using the UI of FIG. 3 in accordance with one or more embodiments of the invention;

FIG. 6 illustrates the logical flow for connecting steel elements in accordance with one or more embodiments of the invention;

FIG. 7 illustrates an exemplary result of the logical flow with multiple connections generated and placed in a BIM model;

FIG. 8 is an exemplary hardware and software environment used to implement one or more embodiments of the invention; and

FIG. 9 schematically illustrates a typical distributed/cloud-based computer system in accordance with one or more embodiments of the invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Steel Connections

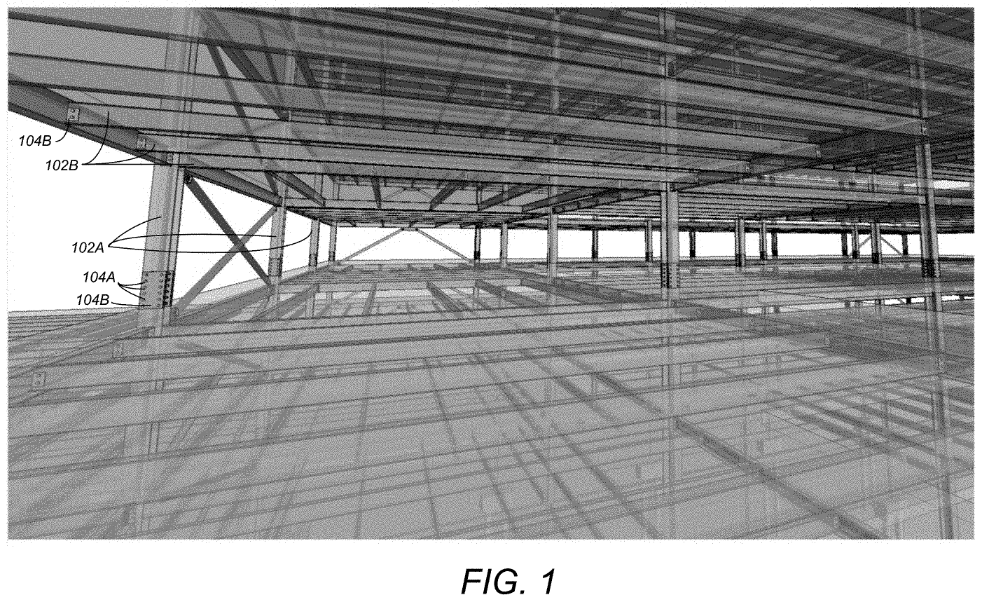

As used herein, steel connections refer to bonders (e.g., bolts, welds, steel plates, and other small steel profiles) that help people join steel elements (e.g., beams, columns, and plates). FIG. 1 illustrates exemplary steel connections utilized in accordance with one or more embodiments of the invention. More specifically, FIG. 1 illustrates the exemplary steel elements 102 of columns 102A and beams 102B. Further, FIG. 1 illustrates the exemplary steel connection elements of bolts 104A, and plates 104B.

As described above, the process for creating and placing steel connections (e.g., in building projects or any project made out of steel elements) is time consuming for structural engineers, for steel detailers, or anyone dealing with the steel connections. Accordingly, it is desirable to automate the design to detailed model transition to improve the efficiency for one of the most time-consuming authoring tasks—i.e., the generation and placement of steel connections in a manner that takes into consideration the structural engineering specifications and information from other parties involved in the project (e.g., fabricators or other team members that have individual preferences that need to be considered during automation). It is further desirable to make it easy for users to adopt the steel connection generation and placement workflow (e.g., to utilize such capability out of the box) (i.e., without significant training) while also enabling the ability to customize the process/steel connections as needed.

Embodiments of the invention provide the above-described capabilities while also enabling faster design intent modeling (i.e., the ability to transition from a model to a model with connections) and earlier estimation capability (i.e., the constructability and cost for entire models with connections including a bill of materials). In this regard, as steel connections can be quickly and efficiently generated and placed, cost estimates may be generated quickly and earlier (e.g., by quickly generating multiple design options) thereby enabling the submission of project bids at an early/earlier stage than previously possible. Further to the above, embodiments of the invention reduce iterations with fabricators for connections modeling because particular fabricator preferences can be embedded/stored and mapped into a system such that future iterations with that particular fabricator are reduced. In addition, new business opportunities may be available to various team members. For example, in the past, structural engineers often did not work on connections. Using embodiments of the invention, structural engineers can generate and place connections as part of their engineering work product.

### Steel Connection Placement

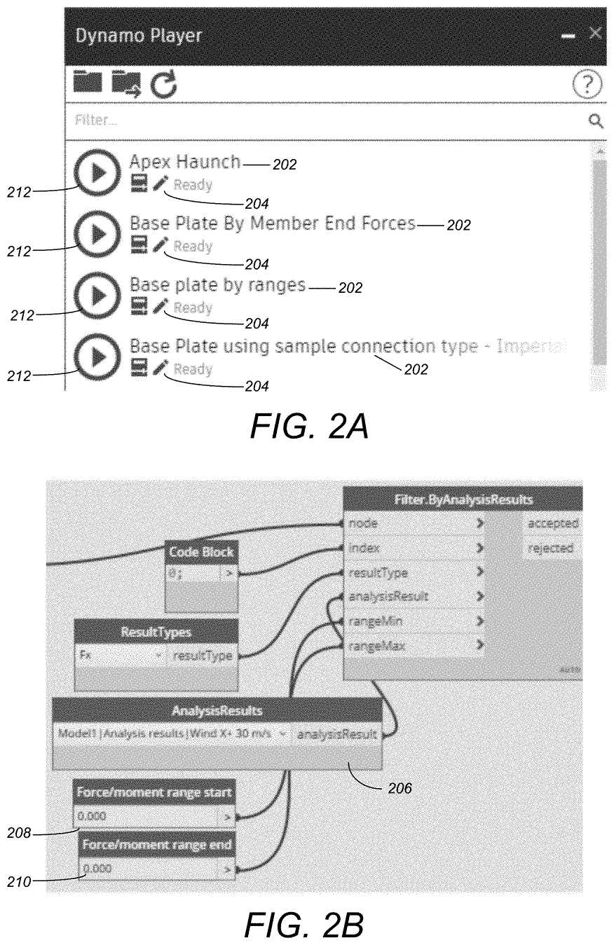

The DYNAMO script is a visual programming platform for the REVIT architecture, engineering, and construction BIM software (available from the Assignee of the present application). More specifically, rather than programming using text, DYNAMO REVIT visual programming replaces code with nodes and wires to form a script that automate repetitive tasks, explore complex design problems, and streamline BIM workflows in BIM models. In one or more embodiments of the invention, DYNAMO REVIT programming is enabled for steel connections such that a script can be generated that incorporates basic geometric engineering rules to place steel connections. FIG. 2A illustrates an exemplary DYNAMO script player, which is a REVIT BIM modeling application feature, that is used to execute/play DYNAMO scripts 202 that place steel connections. By clicking on the edit icon/pencil 204 of a script 202, the user can adjust manual preferences. FIG. 2B illustrates a DYNAMO script user interface, available in the DYNAMO REVIT programming add-in, where preferences can be adjusted. For example, the user can edit/adjust the analysis result 206, the force/moment range start 208, and/or the force/moment range end 210.

In FIG. 2A, once the “play” button 212 is selected, the corresponding script 202 is run/played/executed thereby automatically modeling steel connections for similar elements based on simple geometric rules. The interfaces illustrated in FIGS. 2A and 2B are limited to very simple geometric rules that can be used to position steel connections.

Engineers in the prior art often may generate connections based on tables containing all of the different connections that are expressed in different standards. In such prior art systems, the engineers had to recreate, based on the tables, digital connections from scratch for every connection. Alternatively, prior art users had to browse through prior projects, import all of the connections from such projects, delete unnecessary connections, and then copy and place the connections from such imported connections manually one at a time. Such prior art systems were inefficient and impractical. In contrast, embodiments of the invention build and provide digital libraires of connection types. More specifically, pre-configured connection types stored in digital libraries are automatically loaded. Further, the BIM software may be programmed such that a particular combination of steel elements (e.g., plates and bolts) having specific geometric characteristics correspond to a particular connection in an imported library.

In addition to placing connections based on simple geometric rules, it is also desirable to utilize structural analysis results to determine the type of connection to utilize and place. More specifically, engineers need to place connections based not only on geometrical rules, but also on structural analysis results. Prior art systems only allowed placement based on geometric rules or a set of rules that were inflexible or not easy to use—requiring computational design skills (i.e., a skillset that the vast majority of structural engineers lack).

In embodiments of the invention, DYNAMO nodes and/or rules within the connection automation workflow may use/read the analysis data/results from BIM structural analysis software (e.g., the ROBOT STRUCTURAL ANALYSIS PROFESSIONAL structural analysis software available from the Assignee of the present application). Such BIM structural analysis software may consist of structural analysis that verifies code compliance and uses BIM integrated workflows to exchange data with an underlying BIM application and provide member end forces/load values for elements/connections of a BIM model. Such a structural analysis is critical for structural engineers to determine how and what type of steel connections to utilize. In view of the above, embodiments of the invention may use/read the analysis data from the BIM structural analysis software as part of the process for determining what type of connection to use (e.g., based on member forces).

In view of the above, embodiments of the invention provide a new way for engineers to define rules that dictate where connections should be placed. Such capability provides a universal language that allows any engineer, from any country, using any standard, to map their rules into a BIM software application, in order to automate the connections generation and placement process. Such capability moves logic from a scripting language (e.g., the DYNAMO REVIT scripting language) into a BIM software application (such as the REVIT BIM modeling application), meaning structural engineers no longer need to have computational design skills.

More specific to the above, embodiments of the invention enable the ability to define rules that associate steel connection types to their structural input elements, based on steel profile properties, and steel grade and member end forces. Such capability allows the user to create better steel connection libraries by incorporating rules defined in typical standards and to automate their placement using a script player and/or scripts. Further, preferences of a given user may be defined within the rules.

As used herein, the definition of rules/connections are also referred to ranges of applicability that are attached to the connection type. In other words, the user may define the ranges of parameters that connection types may be associated with. To define association rules for a connection type:
(1) In the model, select the connection and click Edit Type in the Properties Palette.
(2) In the Type Properties dialog, click the Edit button next to Modify Ranges of Applicability.
(3) This will open the Edit Connection Ranges of Applicability dialog for that connection type, where the user can define the ranges.

Association rules may be saved in cases (groups of rules) and multiple cases can be attached to a single connection type. Association rules are attached to a specific connection type, so duplicating a connection type will also duplicate its attached association rules. If the members of a structure node meet all of the conditions of any of the range cases, the connection will be automatically applied in that specific situation. Rules can be defined based on a variety of parameters including the section shape parameters of input members (geometrical and nominal weight), the family and section names of input members, and/or the material and member end forces of input members. For any parameter, the user can also specify that there will be no rule for the respective input element (e.g., by selecting “Any” for that parameter). Further, users can set ranges for structural forces only for the end of the structural elements—if a connection is placed on the body of the structural elements, ranges for member forces should be defined for the end of the element that is fixed by the connection (e.g., a connected beam).

For ranges related to end member forces, the different sign convention between BIM software application end member forces and structural analysis software end member forces may be considered. In one or more embodiments, the sign convention for the structural analysis software is applied for a range definition of end member forces. Thereafter, ranges for end member forces may be validated against imported values, and sign mapping may be applied according to the differences in the two sign conventions.

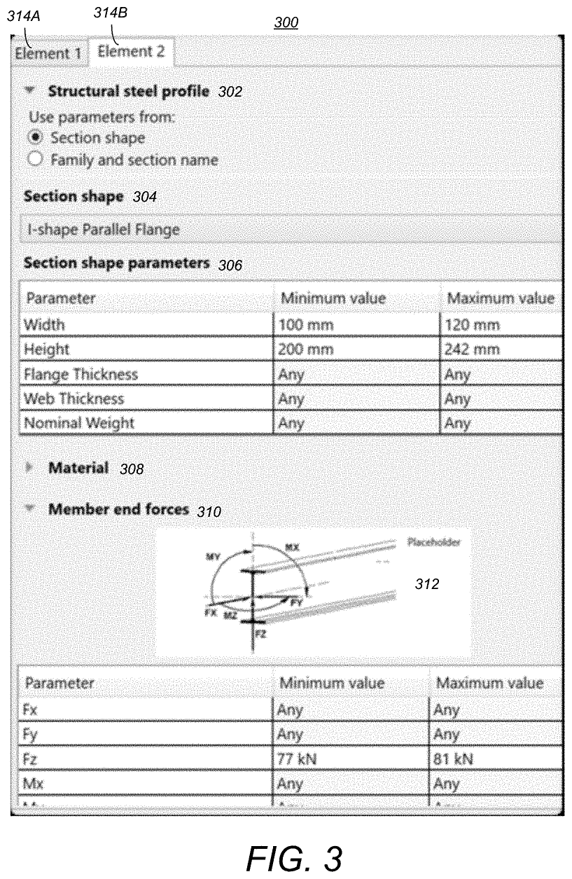

FIG. 3 illustrates a user interface (UI) for defining connection rules/ranges of applicability (for a connection) in accordance with one or more embodiments of the invention. As illustrated, the user interface 300 enables the ability to identify the structural steel profile 302 to utilize for the connection (e.g., section shape or family and section name), identify a section shape 304, specify section shape parameters 306 (e.g., minimum and maximum values for the width, height, flange thickness, web thickness, nominal weight, etc.), identify the material 308, and specify parameters for the member end forces 310 (e.g., minimum and maximum values for Fx, Fy, Fz, Mx, My, and Mz) that are illustrated in image 312.

As illustrated, the UI 300 provides the ability to specify both geometric properties (e.g., height, width, etc.) 306 as well as member end forces 310 for a connection. Such forces may be manually written by structural engineers or may be translated/mapped manually from publicly available standards/tables/design and fabrication specifications/etc. Further, particular preferences/desires of a user/structural engineer may be incorporated via the parameters.

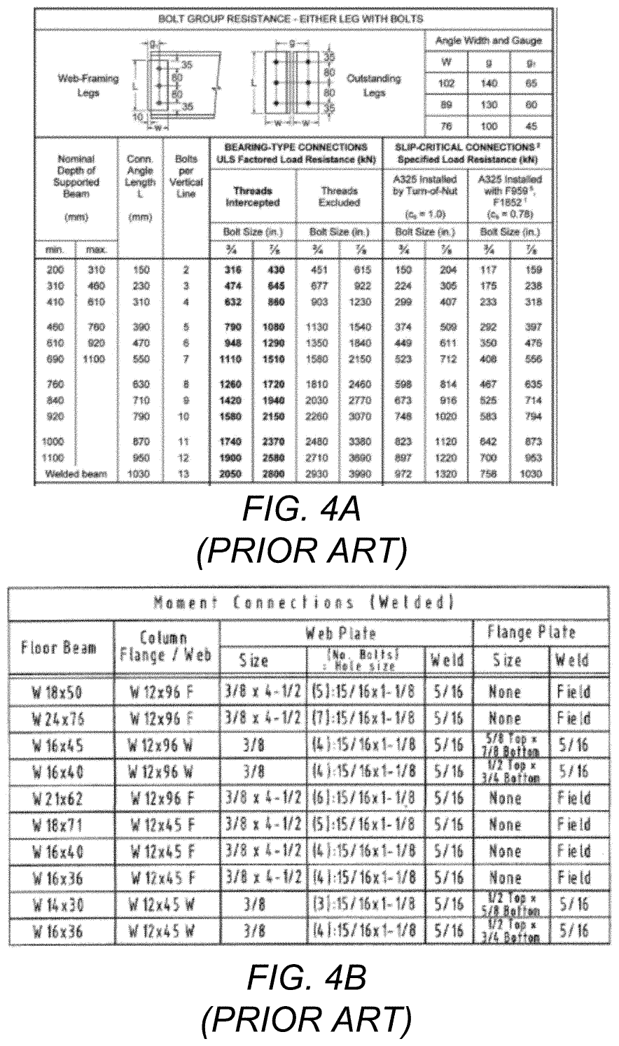

FIGS. 4A and 4B illustrate exemplary tables (for bolt group resistance and moment connections respectively) that may be considered by the structural engineer when defining the connection/connection rule via UI 300. Accordingly, UI 300 provides the ability for a structural engineer to specify that a connection only works with a specified set of forces and a particular range of profiles/boundaries. In one or more embodiments, there is a 1-to-1 correspondence such that for each connection, there is only a single interval/range that is applicable (e.g., for a given set of geometry/forces, a single connection exists).

In view of the above, embodiments of the invention associate connections with profile sizes/particular connections by using ranges of applicability attached to the connection types.

As described above, embodiments of the invention automatically create structural steel connections that (in addition to the geometric aspects described) rely on rule-based solutions according to standard provisions or company good practice guidelines. More specifically, to use steel connections with ranges of applicability, users: (1) Define the ranges of applicability for steel connections in a connection type properties dialog of a BIM application (e.g., the UI 300); and (2) Use provided ranges in sample scripts via a script player to place connections in the model using previously defined connection types in a current or external model (e.g., connections library file).

### Provided Sample Scripts

In addition to defining rules, embodiments of the invention may provide sample scripts/rules for placing steel connections based on their defined ranges of applicability. The following are some exemplary sample scripts that may be provided in accordance with one or more embodiments of the invention:
Base plate by ranges—this script places base plate connections on vertical or slanted columns;
Beam end to end by ranges—this script places connections on two colinear beams;
Beam to beam by ranges—this script places connections on two beams where one meets the other anywhere along its span and at an angle, typically 90°.
Beam to Column by ranges—this script is more appropriate for columns made of non I-shaped profiles (e.g., RHS, CHS), but can also be used for I-shaped profiles when it is not important whether the beam connects to the column web or flange;
Beam to Column web or flange by ranges—this script is more specific for I-shaped columns (e.g., all W or IPE profiles) where it is important whether the beams connect to the column web or to its flange;
Double brace by ranges—this script places connections, such as double gusset, where two braces meet a horizontal beam;
Single brace to beam by ranges—this script places a connection between a brace and a horizontal beam;
Single brace to Column by ranges—this script places a connection between a brace and a vertical column;
Triple brace by ranges—this script places a connection where three braces meet a horizontal beam;
Two beams to one column by ranges—this script is more appropriate for columns made of non I-shaped profiles (e.g., RHS, CHS), but can also be used for I-shaped profiles when it is not important whether the beams connect to the column web or flange; and
Two beams to one column web or flange by ranges—this script is more specific for I-shaped columns (e.g., all W or IPE profiles) where it is important whether the beams connect to the column web or to its flange.

### Steel Connections Library Content

Embodiments of the invention may provide sample libraries of connections, based on the most used standards, to facilitate user's onboarding with the workflow of the invention. Thus, once the connection/rule is created in the UI 300, it may be stored in one or more connection libraries along with the ranges of applicability for that connection.

Once the libraries have been established, they may be used to generate and place steel connections in a given BIM model. For example, embodiments of the invention process the library searching for matches for both geometry and forces that apply to geometry/forces in the given model. Further to the above, different libraries may be generated, selected by a user, and used to accomplish different goals. For example, if the user's goal is to minimize costs (e.g., for an industrial project), a first library may be selected. Alternatively, if the user's goal is to have higher end aesthetics (e.g., for a high-end commercial/residential project), a different library may be selected. In this regard, different libraries may utilize different specific connections/manufacturers/materials and may be used for different purposes.

When using a script to automatically place steel connections associated with profile sizes, the script needs a source of content (a library file) that contains the connection types configured with the desired geometrical parameters and an associated range of applicability, that tells the script what criteria the input members need to match to allow the insertion of that connection in the BIM model.

The source of content can be an external BIM model file that stores the preconfigured connection types, or the script can use a current BIM model file from which the rule is applied. Steel connections with ranges of applicability can be defined and stored into a dedicated library file. The library file can be reused for each working project, by using scripts that will load and apply into the project only the connection types that fit the situations described by the defined range cases.

When creating a connection library file, a script may be configured such that it will always use the current model first, during each run, even if a library is selected. If a connection type is present both in the current model and in the external library file, then the connection type in the current model may always be chosen. In this regard, a script may be configured such that it will not overwrite connection types loaded in a model.

In view of the above, embodiments of the invention create libraries using logic based on international standards (e.g., AISC US standards, German DSTV standards, British BCSA standard, etc.) and/or the expansion of predefined libraries. Such libraries may contain hundreds or thousands of configuration connections. Thereafter, the libraries are used to automatically apply popular typical steel connections (and thereby avoiding the need to manually enter values into a user interface and/or manually configure connections).

In one or more embodiments different libraries may be generated/provided based on different international standards. For example, one or more connection libraries may be based on the AISC Steel Construction Manual (e.g., one based on the 14^{th} edition and another based on the 15^{th} edition). Such connection library content depends on the US imperial structural steel profiles. Further, such a library file may serve as a starting point for users to build custom company standards. For example, the AISC construction library may consist of thirteen (13) library files containing a total of 726 BIM connection types with attached ranges of applicability defined based on the AISC Steel Construction Manual (e.g., based on different AISC manual tables for different connections such as “all-bolted double-angle connections”, “available weld strength of bolted/welded double-angle connections”, “bolted/welded shear end-plate connections”, etc.).

The connection types may also follow a naming convention that describes the category of connected elements (e.g., beam to beam, beam to column, or column to column), the relative position of the supported element to the flange or to the web of the supporting element (e.g., flange or web), the connection method (e.g., both angle legs bolted, angle leg bolted to supporting and angle leg welded to supported beam, angle leg welded to supporting and angle leg bolted to supported beam, and both angle legs welded), information about the bolts including their diameter, grade and number of bolt rows (e.g., ¾″ diameter bolts, group A 325 bolts, etc.), information about the width and length of the seat, information about the angle profile or the plate of the connection (e.g., ⅜″ angle profile thickness for a clip angle connection), thickness, range of column sections, and type of connection (e.g., column splice 2 elements connection, single clip angle 2 elements connection, double clip angle 3 elements connection, double end plate 3 elements connection, etc.).

### Exemplary Range of Applicability Based on the Standard

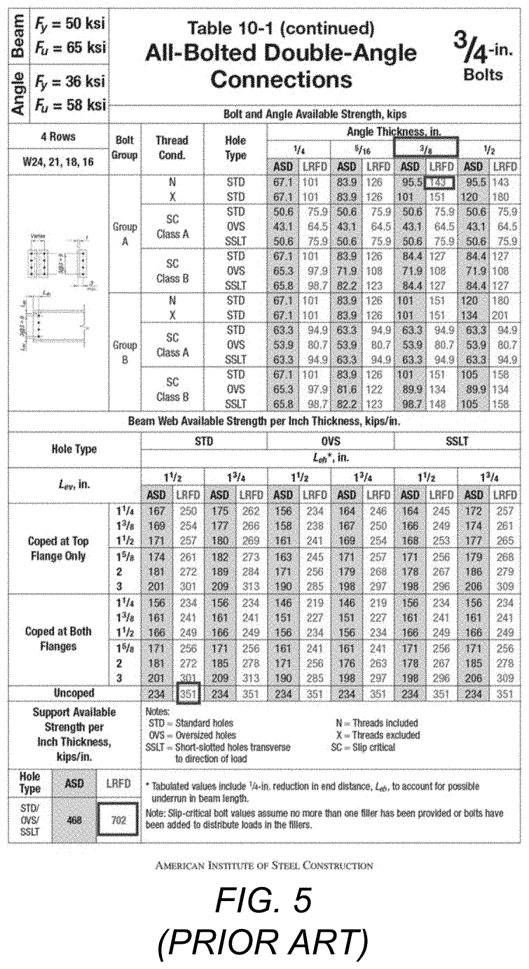

An exemplary range of applicability based on the standard shows a couple of connection types and how the ranges of applicability may be calculated, including the internal forces. As an example, “B to B Web BB ¾ A325 4 No 3/8L SCA” connection type is a beam to beam, bolted on both legs, 4 rows of bolts with ¾″ diameter, ⅜″ angle thickness, single clip angle connection. Because this is an all bolted connection, only one table in the standard needs to be examined—AISC Table 10-1.FIG. 5 illustrates Table 10-1 that is examined for the given connection in accordance with one or more embodiments of the invention. According to AISC table 10-1, the following conditions can be implemented in the ranges of applicability:
Fz:±143 kips—the maximum shear force for the supported beam.
143 kips/351 kips/in=0.407 in—the minimum web thickness of the supported uncoped beam.
143 kips/702 kips/in=0.204 in—the minimum web thickness of the supporting beam.

The 14^{th} edition of the standard specifies a supported beam web thickness of 0.407 in or greater. To cover situations for thinner profiles, the shear force can be calculated considering the thinner web thickness of the beam. This means that three additional cases can be defined for the ranges of applicability:
(1) Supported beam with a shear capacity above the bolt strength and the angle strength, meaning all the beams with a web thickness greater than 0.407 in.
(2) Supported beam with ⅜″ thickness, the shear capacity of the connection will be adjusted to the maximum shear strength of the supported beam: Fz=⅜ in×351 kips/in =131.625 kips.
(3) Supported beam with 5/16″ web thickness, the shear capacity of the connection will adjusted to the maximum shear strength of the supported beam: Fz= 5/16 in×351 kips/in=109.687 kips.
(4) Supported beam with ¼″ thickness, the shear capacity of the connection will be adjusted to the maximum shear strength of the supported beam: Fz=¼ in×351 kips/in=87.75 kips.

“Element 1”, which is the supporting beam, has no shear force condition. The web thickness resulted from the calculation above is at least 13/64 in, considering a tolerance of 1/64 in. It is good to have a condition for the minimum height parameter of the supporting beam, because it depends on the smallest profile of the supported beam and the standard encroachment limitation. The supported beams are the ones between W16×26 and W24×370. The smallest profile is W16×26 and it has a minimum supported beam height of 15 ¾″. Calculating the supporting beam minimum height, we get 3×3″ (bolt distance between rows)+2×1″ (rolled edge distance)+3 ⅝″=1′ 2 ⅝″=14 ⅝″. Looking through table 1-1 for W-shapes we see that the smallest profile for the supporting beam is W14×132.

Further to the above, various ranges for four different cases may be calculated for “Element 2” which is the supported beam. FIG. 3 illustrates different tabs 314A and 314B that may be used to defined the structural steel profile for different steel elements that are being connected.

Once the AISC library above has been retrieved/loaded, the connection automation feature may be used to place several types of connections in the model using the library. To perform such placement, various scripts may be needed/utilized. A search feature may be utilized to find the needed scripts (e.g., searching for “web or flange by ranges” will show the scripts “Beam to Column web or flange by ranges” and the “Two beams to one column web or flange by ranges” scripts.

Once the scripts have been identified, a “Connection Automation” button may be selected to open a script player that lists the identified scripts. Once the desired script is selected, parameters may be specified (e.g., a beam slope angle [e.g., 5 degrees] may be input to place connections on slightly sloped beams). Thereafter, the library files needed are identified, the connection family is checked, and any filters for the connection type name may be specified. The analysis results source (e.g., “Revit Member End Forces” or any load case from imported structural analysis software results) are selected, and the script is executed. The script then autonomously generates and places the connections based on all of the selections.

Additional examples may include the use of a BCSA library, and/or a DSTV library (i.e., a German DSTV standard with a connection library that depends on European structural steel profiles).

### Connection Library and Standards Mapping

The different standards (e.g., AISC, BCSA, DSTV, etc.) may be mapped into a BIM software application in accordance with embodiments of the invention. For example, out-of-the box content may consist 2×13 library files containing 2×733 connection types with attached ranges of applicability defined based on various standards such as the AISC Steel Construction Manual 14^{th} and 15^{th} Edition specifications. In this regard, each connection library may be built based on specific geometric assumptions for a connection configuration. In other embodiments, the out-of-the box content may consist of 7 library files containing 378 connection types with attached ranges of applicability defined based on specifications in SCI & BCSA Publication 358 (“Joints in Steel Construction—Simple Joints to Eurocode 3”, 2014 Edition”). In another embodiments, the out-of-the box content may consist of 9 library files containing 293 connection types with attached ranges of applicability defined based on DSTV—“Typisierte Anschlüsse im Stahlhochbau nach DIN EN 1993-1-8”(“Standardized Joints in Steel Structures to DIN EN 1993-1-8”) 2013 Edition.

### Sorting Library Connection Types by Name Alphanumerically

As described above, embodiments of the invention may provide a set of scripts that place connections based on attached ranges of applicability. Such a script set may use a PYTHON script node to allow a better ordering that takes into account numeric values. The numbers can be positioned anywhere in the name, and as many as needed. For example, the following connection type names may be ordered correctly: (1) Base plate 8; (2) Base plate 9; (3) Base plate 10. The ordering should also work correctly for numbers with decimals using a regional settings decimals separator.

Ordering may also consider fractions denoted by the “/” character, with or without the whole part. For example, the following may be ordered correctly: (1)

Base plate 3/16; (2) Base plate ¼; (3) Base plate ½; (4) Base plate 1; (5) Base plate 1 ½; and (6) Base plate 1.6. Different units may also be resolved for the ordering (e.g., an Imperial format may be identified, but interpreted differently for two connection types names)(e.g., Base plate 1′ ¼ may be resolved to Base plate 1 foot and 0.25 a separate number.

### Rule Customization

Any and all of the above described out-of-the box content may be extended based on user's specific requirements. In other words, rules/scripts (the sample provided scripts or user-generated scripts) may be tweaked/customized by users in order to improve automation routines and/or personalize/define user preferences. Such rule/script customization may be performed with respect to geometric rules and/or the structural analysis portions via the user interface (e.g., of FIG. 3) or within a script (e.g., DYNAMO script) itself. Such rule customization may include the embedding of important rules to improve QA/QC, the automation while considering all driving factors, etc.

As an example, a rule/script editor may be used to edit a rule/script to enable the placement of connections by using the connection libraries configured with ranges of applicability. More specifically, a script may be combined with an automation node (i.e., of the script) to filter out and apply the steel connection that fits each individual connection node from a selection. Model elements are selected and the structural elements may be grouped into potential connection nodes. Connection nodes may then be filtered based on the relative position of the input element (e.g., type of element intersection [end to end, end to body, etc.], relative position of the elements [beam to column web, beam to beam flange, etc.], absolute orientation of elements [e.g., first element is vertical in the model or sloped/slated at a set angle], and angle between eh elements). The connection nodes that pass the geometric filtering are then considered by the ranges validation node that has an input to a connection family from a source (library file or current model) and the source of the analysis results. The ranges validation node will take each node and validate it against the ranges defined for the connection types configured in the source connection family. With respect to the validation: the validation may be done one connection type at a time; if the ranges of applicability of the checked connection type match the parameters set for the input members in that connection node (e.g., profile sizes, section parameters, material, member end forces), the connection type will be created in that specific connection node; If the ranges of applicability of the checked connection type do not match (for example the Fx on member two is outside the configured range), then the validation will go forward with the next connection type in the chosen connection family source; and the connection types in the library files will be automatically sorted in their alphabetical order and will be checked for validation in this order (from first to last).

On the same run, the script can create different connection types in the BIM model according to their attached ranges and the validated situations. In one or more embodiments, The provided sample scripts contain all the necessary nodes to enable the placement of steel connections using the predefined ranges of applicability from the connection type.

### Script Execution

To utilize scripts/rules (i.e., either sample provided scripts or manually created scripts), embodiments of the invention may use a script player (e.g., the DYNAMO script player). Rule configuration within a script player may include:
(1) Additional relative position filtering, where needed: For example, in a provided “Beam to column web or flange ranges” sample script, the relative position filtering may include the beam slope/tilt angle ranges. By default, it is configured with the value 0→horizontal beam, and it can be changed before each run, if needed.
(2) On column web=true (on column flange=false): Leave “True” if the connections to be placed are fixed on the column web OR check “False” for fixing the beams to the column flanges.
(3) Library file path: select the library file to be used by the rule.
(4) Connection family to place: the name of the connection to be placed by the rule run.
(5) Only connection types whose names contain these words (leave empty for all): fill in the text strings present in the connection types you want to place. Spaces will act as separators between strings. The order of the text strings is not relevant for filtering.
(6) Analysis Results: the rules can be configured to validate against the analysis data stored in the model. The supported sources may be an analytical model or a results builder that can store analytical data coming from structural analysis software (or any other software that can transfer to a structural analysis toolkit/API).

As an example, a provided script may be run to connect beams intersecting the column on its web. To invoke/play such a script, one first identifies the portion of the model that the script will be used for. For example, a window selection method may be used to identify/select elements within a BIM model (such a selection may include non-steel elements—the rule will filter out and only consider structural steel framing elements including columns, beams, bracings, etc.). Once selected, the play button of a selected/identified script is clicked.

Pursuant to execution of the script a report of what was applied may be generated. For example, a report may include a breakdown of connections that were created such as: (1) created—the number of connections created by the rule during the run; (2) existed—counts all the connections already present in the situations where the current script run found applicable situations—the script may only create new connections where none exist, and does not replace or update existing connections even if the support elements were part of the current selection; (3) applicable—counts all the connection nodes that could get a connection (where validated by the ranges of applicability); (4) potential situations—all of the connection nodes that passed the initial relative geometry validation—the difference from “applicable” comes from connection nodes that were accepted from a relative geometry point of view (e.g., in this case they were a column and beam suitable for a connection) but did not pass the ranges of applicability validation. If no connection type has matching ranges for the analyzed situations, a message may be delivered in the report identifying such an occurrence.

### Logical Flow

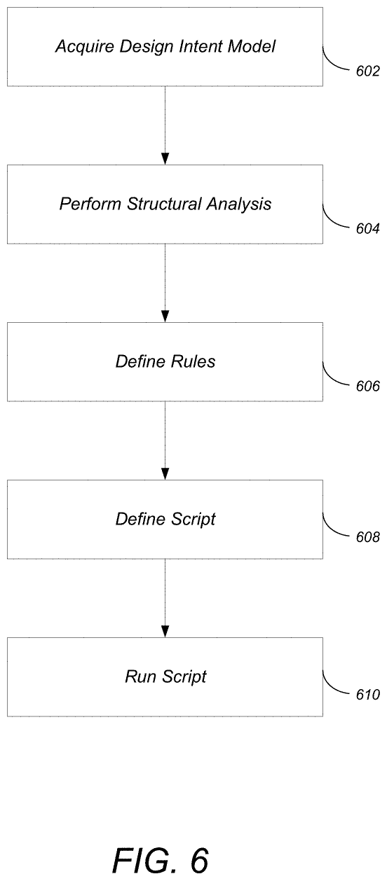

FIG. 6 illustrates the logical flow for connecting steel elements in accordance with one or more embodiments of the invention.

At step 602, a design intent model is acquired. The design intent model is a building information model (BIM) of a skeleton of a building without connections between steel elements (i.e., not all steel element intersections have connections and/or some/all of the connections are missing). In addition, the design intent model consists of the steel elements having first geometric characteristics.

At step 604, a structural analysis of a structure of the design intent model is performed resulting/generating structural analysis output. The output provides forces at one or more intersections of the steel elements. In one or more embodiments, the structural analysis is performed by structural analysis software and results/output from the software is imported.

At step 606, one or more rules are defined via a user interface. The rules associate a potential connection with a structural steel profile (and/or one or more structural steel profiles). The rules, together with a script dictate where one or more connections should be placed.

At step 608, a script is defined via the user interface. The script dictates where one or more connections should be placed. Further, the script identifies in the structural steel profile: (1) one or more second geometric characteristics of the potential connection, and (2) one or more forces for one or more of the steel elements to be connected via the potential connection. The script compares the design intent model, structural analysis output, and the one or more rules to the structural steel profile(s). In addition, the script generates and places, based on the comparison, the one or more connections on the BIM model at applicable intersections.

The definition of the script may include section shape parameters for the geometric characteristics of the potential connection. Such parameters may include: a width minimum value and a width maximum value; a height minimum value and a height maximum value; and a nominal weight minimum value and a nominal weight maximum value. Other parameters may be specific to particular shapes (e.g., I-section shapes such as flanges and/or non-I section shapes). For example, additional parameters may include: a flange thickness minimum value and a flange thickness maximum value; a web thickness minimum value and a web thickness maximum value; a wall nominal thickness minimum value and a wall nominal thickness maximum value; and a diameter minimum value and a diameter maximum value. In addition, the script definition may specify/define a material for the potential connection. With respect to the one or more forces, the definition may specify/define member end forces such as: an Fx minimum value and an Fx maximum value; an Fy minimum value and an Fy maximum value; an Fz minimum value and an Fz maximum value; an Mx minimum value and an Mx maximum value; an My minimum value and an My maximum value; and an Mz minimum value and an Mz maximum value.

At step 610, the script is run/executed. Such execution autonomously updates the BIM model with the one or more connections generated and placed.

In one or more embodiments of the invention, step 606 may also include the use/generation of libraries of connections. In such embodiments, the defined script and the library may be stored. Different libraries may be used/generated for different purposes. For example, one library may contain connections based on one or more standards. Such standards may be national or international standards (e.g., defined by governing bodies or national structural engineering associations), company-specific standards, industry best practices, etc. In addition, multiple different predefined libraries may be provided to users that incorporate design and fabrication specifications. Further, such libraries may be adapted/modified to incorporate a change in design intent. For example, a library based on standards may be expanded to incorporate a user's personal preferences (e.g., to utilize aesthetically pleasing connections and/or cost efficient connections).

When libraries are utilized, steps 606-610 may also include the selection of the script, the selection of the library, and the running/execution of the script on a different BIM model. In this regard, a script may be created with respect to a first BIM model, the script is stored along with a library, and then that same script may be executed on a different BIM model to easily and efficiently place connections. Further, the script defines he intent for kinds of connections and the logic to identify appropriate locations nit he BIM model, while the library defines he individual connection configurations.

Further to the above, a library of connections may consist of multiple different types of potential connections. In one or more embodiments, all of the potential connections in the library are autonomously compared to the design intent model and structural analysis output. Pursuant to such a comparison, multiple different types of potential connections are autonomously generated and placed (e.g., without additional user input) on the BIM model at applicable intersections. In other words, once a user selects a library to apply to a given design intent model, the system will compare all connections in the model to the ranges of applicability set forth in the different connections of the library, and generate and place connections based thereon. In one or more alternative embodiments, the user may be prompted to either accept or decline particular placed connections, and/or all of the connections, and/or all connections of a particular type, etc.

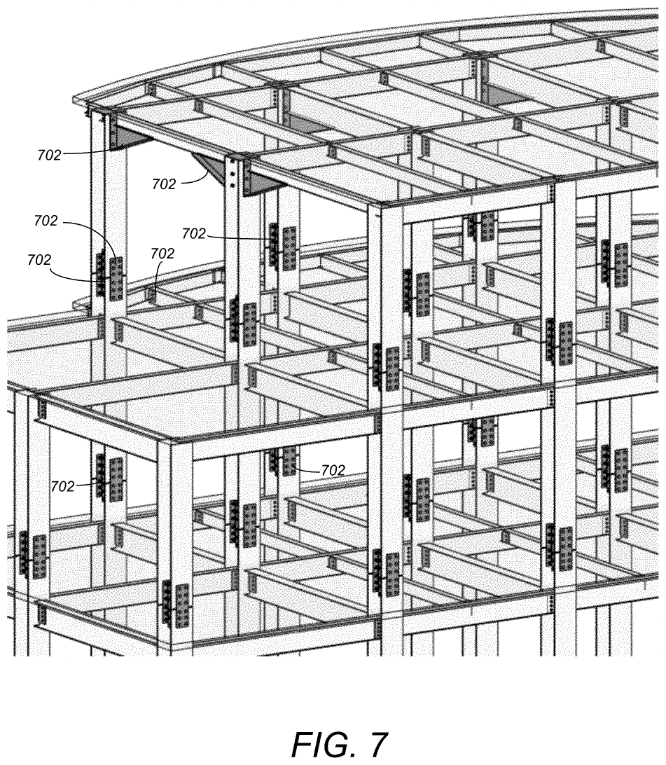

FIG. 7 illustrates an exemplary result of the logical flow with multiple connections generated and placed in a BIM model. As illustrated, multiple different connections 702 have been generated and placed in a BIM model at various intersections between beams and columns. In the prior art, each of such connections had to be placed manually one at a time by a user consuming significant time and energy. For example, to generate and place 4,500 connections in a model could consume several days using prior art methodologies. In contrast, using the automation and workflow of embodiments of the invention such 4,500 connections could be generated and placed in approximately 20 minutes.

### Hardware Environment

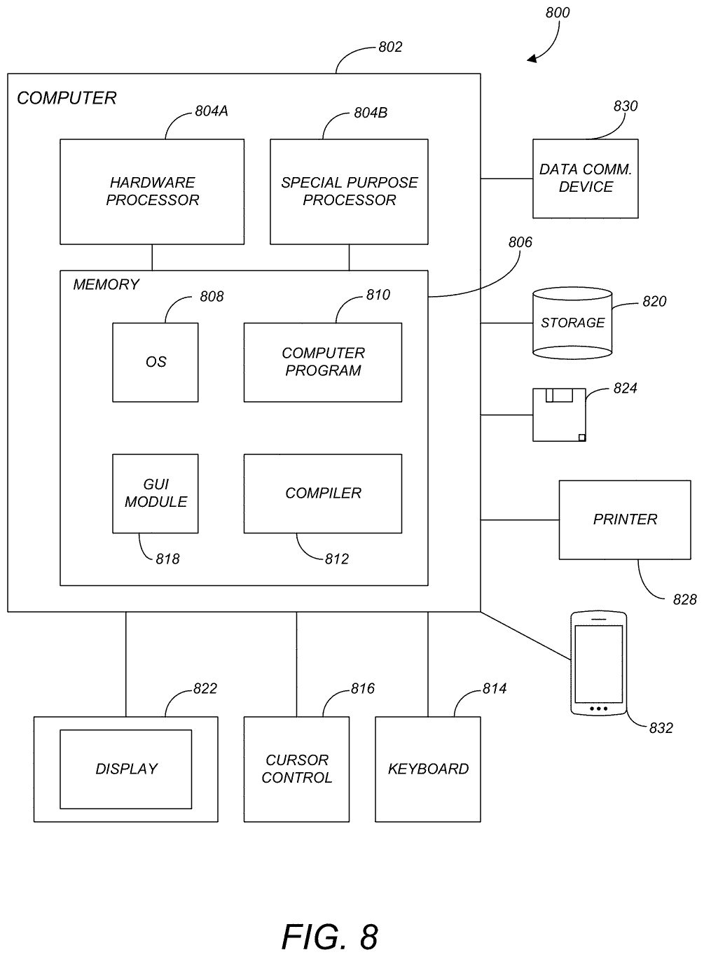

FIG. 8 is an exemplary hardware and software environment 800 (referred to as a computer-implemented system and/or computer-implemented method) used to implement one or more embodiments of the invention. The hardware and software environment includes a computer 802 and may include peripherals. Computer 802 may be a user/client computer, server computer, or may be a database computer. The computer 802 comprises a hardware processor 804A and/or a special purpose hardware processor 804B (hereinafter alternatively collectively referred to as processor 804) and a memory 806, such as random access memory (RAM). The computer 802 may be coupled to, and/or integrated with, other devices, including input/output (I/O) devices such as a keyboard 814, a cursor control device 816 (e.g., a mouse, a pointing device, pen and tablet, touch screen, multi-touch device, etc.) and a printer 828. In one or more embodiments, computer 802 may be coupled to, or may comprise, a portable or media viewing/listening device 832 (e.g., an MP3 player, IPOD, NOOK, portable digital video player, cellular device, personal digital assistant, etc.). In yet another embodiment, the computer 802 may comprise a multi-touch device, mobile phone, gaming system, internet enabled television, television set top box, or other internet enabled device executing on various platforms and operating systems.

In one embodiment, the computer 802 operates by the hardware processor 804A performing instructions defined by the computer program 810 (e.g., a computer-aided design [CAD] application) under control of an operating system 808. The computer program 810 and/or the operating system 808 may be stored in the memory 806 and may interface with the user and/or other devices to accept input and commands and, based on such input and commands and the instructions defined by the computer program 810 and operating system 808, to provide output and results.

Output/results may be presented on the display 822 or provided to another device for presentation or further processing or action. In one embodiment, the display 822 comprises a liquid crystal display (LCD) having a plurality of separately addressable liquid crystals. Alternatively, the display 822 may comprise a light emitting diode (LED) display having clusters of red, green and blue diodes driven together to form full-color pixels. Each liquid crystal or pixel of the display 822 changes to an opaque or translucent state to form a part of the image on the display in response to the data or information generated by the processor 804 from the application of the instructions of the computer program 810 and/or operating system 808 to the input and commands. The image may be provided through a graphical user interface (GUI) module 818. Although the GUI module 818 is depicted as a separate module, the instructions performing the GUI functions can be resident or distributed in the operating system 808, the computer program 810, or implemented with special purpose memory and processors.

In one or more embodiments, the display 822 is integrated with/into the computer 802 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 802 according to the computer program 810 instructions may be implemented in a special purpose processor 804B. In this embodiment, some or all of the computer program 810 instructions may be implemented via firmware instructions stored in a read only memory (ROM), a programmable read only memory (PROM) or flash memory within the special purpose processor 804B or in memory 806. The special purpose processor 804B may also be hardwired through circuit design to perform some or all of the operations to implement the present invention. Further, the special purpose processor 804B may be a hybrid processor, which includes dedicated circuitry for performing a subset of functions, and other circuits for performing more general functions such as responding to computer program 810 instructions. In one embodiment, the special purpose processor 804B is an application specific integrated circuit (ASIC).

The computer 802 may also implement a compiler 812 that allows an application or computer program 810 written in a programming language such as C, C++, Assembly, SQL, PYTHON, PROLOG, MATLAB, RUBY, RAILS, HASKELL, or other language to be translated into processor 804 readable code. Alternatively, the compiler 812 may be an interpreter that executes instructions/source code directly, translates source code into an intermediate representation that is executed, or that executes stored precompiled code. Such source code may be written in a variety of programming languages such as DYNAMO, JAVA, JAVASCRIPT, PERL, BASIC, etc. After completion, the application or computer program 810 accesses and manipulates data accepted from I/O devices and stored in the memory 806 of the computer 802 using the relationships and logic that were generated using the compiler 812.

The computer 802 also optionally comprises an external communication device such as a modem, satellite link, Ethernet card, or other device for accepting input from, and providing output to, other computers 802.

In one embodiment, instructions implementing the operating system 808, the computer program 810, and the compiler 812 are tangibly embodied in a non-transitory computer-readable medium, e.g., data storage device 820, which could include one or more fixed or removable data storage devices, such as a zip drive, floppy disc drive 824, hard drive, CD-ROM drive, tape drive, etc. Further, the operating system 808 and the computer program 810 are comprised of computer program 810 instructions which, when accessed, read and executed by the computer 802, cause the computer 802 to perform the steps necessary to implement and/or use the present invention or to load the program of instructions into a memory 806, thus creating a special purpose data structure causing the computer 802 to operate as a specially programmed computer executing the method steps described herein. Computer program 810 and/or operating instructions may also be tangibly embodied in memory 806 and/or data communications devices 830, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 802.

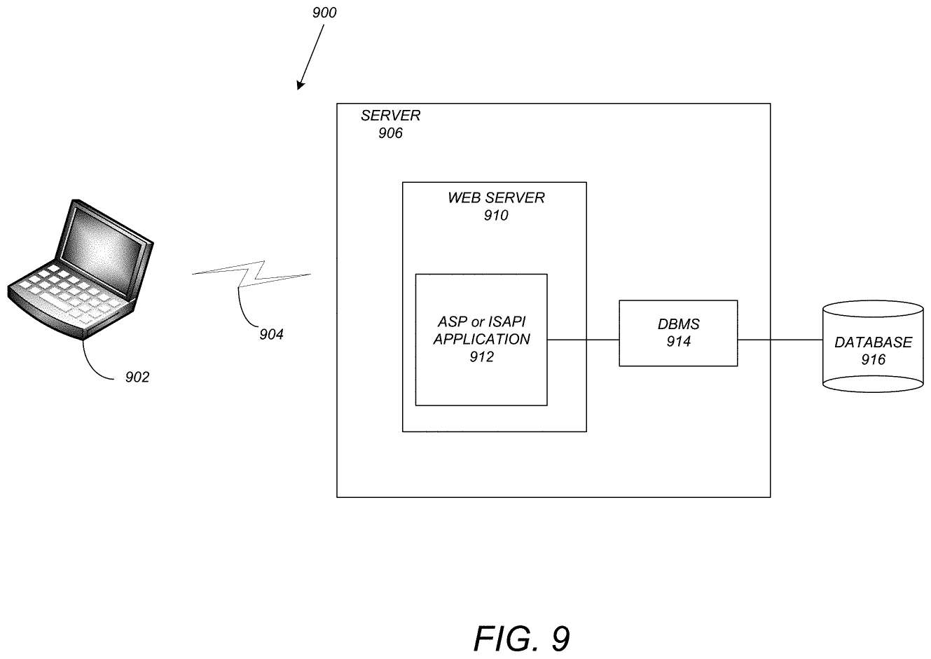

FIG. 9 schematically illustrates a typical distributed/cloud-based computer system 900 using a network 904 to connect client computers 902 to server computers 906. A typical combination of resources may include a network 904 comprising the Internet, LANs (local area networks), WANs (wide area networks), SNA (systems network architecture) networks, or the like, clients 902 that are personal computers or workstations (as set forth in FIG. 8), and servers 906 that are personal computers, workstations, minicomputers, or mainframes (as set forth in FIG. 8). However, it may be noted that different networks such as a cellular network (e.g., GSM [global system for mobile communications] or otherwise), a satellite based network, or any other type of network may be used to connect clients 902 and servers 906 in accordance with embodiments of the invention.

A network 904 such as the Internet connects clients 902 to server computers 906. Network 904 may utilize ethernet, coaxial cable, wireless communications, radio frequency (RF), etc. to connect and provide the communication between clients 902 and servers 906. Further, in a cloud-based computing system, resources (e.g., storage, processors, applications, memory, infrastructure, etc.) in clients 902 and server computers 906 may be shared by clients 902, server computers 906, and users across one or more networks. Resources may be shared by multiple users and can be dynamically reallocated per demand. In this regard, cloud computing may be referred to as a model for enabling access to a shared pool of configurable computing resources.

Clients 902 may execute a client application or web browser and communicate with server computers 906 executing web servers 910. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 902 may be downloaded from server computer 906 to client computers 902 and installed as a plug-in or ACTIVEX control of a web browser. Accordingly, clients 902 may utilize ACTIVEX components/component object model (COM) or distributed COM (DCOM) components to provide a user interface on a display of client 902. The web server 910 is typically a program such as MICROSOFT'S INTERNET INFORMATION SERVER.

Web server 910 may host an Active Server Page (ASP) or Internet Server Application Programming Interface (ISAPI) application 912, which may be executing scripts. The scripts invoke objects that execute business logic (referred to as business objects). The business objects then manipulate data in database 916 through a database management system (DBMS) 914. Alternatively, database 916 may be part of, or connected directly to, client 902 instead of communicating/obtaining the information from database 916 across network 904. When a developer encapsulates the business functionality into objects, the system may be referred to as a component object model (COM) system. Accordingly, the scripts executing on web server 910 (and/or application 912) invoke COM objects that implement the business logic. Further, server 906 may utilize MICROSOFT'S TRANSACTION SERVER (MTS) to access required data stored in database 916 via an interface such as ADO (Active Data Objects), OLE DB (Object Linking and Embedding DataBase), or ODBC (Open DataBase Connectivity).

Generally, these components 900-916 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 902 and 906 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 902 and 906. Embodiments of the invention are implemented as a software/CAD application on a client 902 or server computer 906. Further, as described above, the client 902 or server computer 906 may comprise a thin client device or a portable device that has a multi-touch-based display.

### Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for connecting steel elements, comprising:
(a) acquiring a design intent model, wherein:
(i) the design intent model comprises a building information model (BIM) of a skeleton of a building;
(ii) the design intent model is without connections between steel elements; and
(iii) the design intent model comprises the steel elements having first geometric characteristics;
(b) performing a structural analysis of a structure of the design intent model, wherein:
(i) the structural analysis generates structural analysis output; and
(ii) the structural analysis output comprises forces at one or more intersections of the steel elements;
(c) defining, via a user interface, one or more rules that associate a potential connection with a structural steel profile, wherein the rules together with a script dictate where one or more connections should be placed;
(d) defining, via the user interface, a script that identifies where the one or more connections should be placed, and wherein the script:
(i) identifies, in the structural steel profile, one or more second geometric characteristics of the potential connection;
(ii) identifies, in the structural steel profile, one or more forces for one or more of the steel elements to be connected via the potential connection;
(iii) compares the design intent model, the structural analysis output and the one or more rules to the structural steel profile; and
(iv) generates and places, based on the comparison, the one or more connections on the BIM model at applicable intersections;
(e) running the script, wherein the script autonomously updates the BIM model with the one or more connections generated and placed.

2. The computer-implemented method of claim 1, wherein:
the structural analysis is performed by structural analysis software; and
results of the structural analysis are imported from the structural analysis software.

3. The computer-implemented method of claim 1, further comprising:
storing the script and a library of connections.

4. The computer-implemented method of claim 3, wherein the connections in the library are based on one or more standards.

5. The computer-implemented method of claim 4, wherein the library comprises an expanded library created by expanding a predefined library that is based on the standards.

6. The computer-implemented method of claim 3, the method further comprising:
selecting the script;
selecting the library; and
running the script on a different BIM model.

7. The computer-implemented method of claim 3, the method further comprising:
selecting the library, wherein the library comprises multiple different types of potential connections;
autonomously comparing all of the potential connections in the library to the design intent model and structural analysis output; and
autonomously generating and placing, based on the comparing, the multiple different types of potential connections on the BIM model at applicable intersections.

8. The computer-implemented method of claim 1, wherein the defining comprises:
defining section shape parameters for the geometric characteristics, wherein the parameters comprise:
a width minimum value and a width maximum value;
a height minimum value and a height maximum value; and
a nominal weight minimum value and a nominal weight maximum value.

9. The computer-implemented method of claim 1, wherein the defining comprises:
defining a material for the potential connection.

10. The computer-implemented method of claim 1, wherein the defining the one or more force comprises defining member end forces comprising:
an Fx minimum value and an Fx maximum value;
an Fy minimum value and an Fy maximum value;
an Fz minimum value and an Fz maximum value;
an Mx minimum value and an Mx maximum value;
an My minimum value and an My maximum value; and
an Mz minimum value and an Mz maximum value.

11. A computer-implemented system for connecting steel elements, comprising:
(a) a computer having a memory;
(b) a processor executing on the computer;
(c) the memory storing a set of instructions, wherein the set of instructions, when executed by the processor cause the processor to perform operations comprising:
(i) acquiring a design intent model, wherein:
(1) the design intent model comprises a building information model (BIM) of a skeleton of a building;
(2) the design intent model is without connections between steel elements; and
(3) the design intent model comprises the steel elements having first geometric characteristics;
(ii) performing a structural analysis of a structure of the design intent model, wherein:
(1) the structural analysis generates structural analysis output; and
(2) the structural analysis output comprises forces at one or more intersections of the steel elements;
(iii) defining, via a user interface, one or more rules that associate a potential connection with a structural steel profile, wherein the rules together with a script dictate where one or more connections should be placed;
(iv) defining, via the user interface, a script that identifies where the one or more connections should be placed and wherein the script:
(1) identifies, in the structural steel profile, one or more second geometric characteristics of the potential connection;
(2) identifies, in the structural steel profile, one or more forces for one or more of the steel elements to be connected via the potential connection;
(3) compares the design intent model, the structural analysis output and the one or more rules to the structural steel profile; and
(4) generates and places, based on the comparison, the one or more connections on the BIM model at applicable intersections;
(v) running the script, wherein the script autonomously updates the BIM model with the one or more connections generated and placed.

12. The computer-implemented system of claim 11, wherein:
the structural analysis is performed by structural analysis software; and
results of the structural analysis are imported from the structural analysis software.

13. The computer-implemented system of claim 11, further comprising:
the memory storing the script and a library of connections.

14. The computer-implemented system of claim 13, wherein the connections in the library are based on standards.

15. The computer-implemented system of claim 14, wherein the library comprises an expanded library created by expanding a predefined library that is based on the standards.

16. The computer-implemented system of claim 13, the operations further comprising:
selecting the script;
selecting the library; and
running the script on a different BIM model.

17. The computer-implemented system of claim 13, the operations further comprising:
selecting the library, wherein the library comprises multiple different types of potential connections;
autonomously comparing all of the potential connections in the library to the design intent model and structural analysis output; and
autonomously generating and placing, based on the comparing, the multiple different types of potential connections on the BIM model at applicable intersections.

18. The computer-implemented system of claim 11, wherein the operation defining comprises:
defining section shape parameters for the geometric characteristics, wherein the parameters comprise:
a width minimum value and a width maximum value;
a height minimum value and a height maximum value; and
a nominal weight minimum value and a nominal weight maximum value.

19. The computer-implemented system of claim 11, wherein the operation defining comprises:
defining a material for the potential connection.

20. The computer-implemented system of claim 11, wherein the operation defining the one or more force comprises defining member end forces comprising:
an Fx minimum value and an Fx maximum value;
an Fy minimum value and an Fy maximum value;
an Fz minimum value and an Fz maximum value;
an Mx minimum value and an Mx maximum value;
an My minimum value and an My maximum value; and
an Mz minimum value and an Mz maximum value.
